(19) United States
(12) Patent Application Publication
(10) Pub. No.: US 2018/0093665 A1
(43) Pub. Date: Apr. 5, 2018

(54) COLLISION-INPUT REDUCTION APPARATUS FOR VEHICLE

(71) Applicant: SUBARU CORPORATION, Tokyo (JP)

(72) Inventors: Takao KONDO, Tokyo (JP); Isamu NAGASAWA, Tokyo (JP)

(21) Appl. No.: 15/652,356

(22) Filed: Jul. 18, 2017

(30) Foreign Application Priority Data
Sep. 30, 2016 (JP) 2016-194163

(51) Int. Cl. B60W 30/085

(52) U.S. Cl. CPC B60W 30/085; B60W 2710/18; B60W 2710/20; B60W 2720/106

(57) ABSTRACT

A collision-input reduction apparatus for a vehicle includes a detector configured to detect an approaching object that approaches the vehicle, and a controller configured to control behavior of the vehicle. In response to prediction, based on detection by the detector, of a collision of the approaching object with a side of the vehicle in a direction passing through a center of gravity of the vehicle while traveling, the controller changes the behavior of the vehicle before collision with the approaching object so as to move the center of gravity of the vehicle off an input direction of impact caused by the collision with the approaching object.

### CROSS-REFERENCE TO RELATED APPLICATIONS

The present application claims priority from Japanese Patent Application No. 2016-194163 filed on Sep. 30, 2016, the entire contents of which are hereby incorporated by reference.

### BACKGROUND

### 1. Technical Field

The present invention relates to a collision-input reduction apparatus for a vehicle such as an automobile.

### 2. Related Art

Research on assistance for drivers of automobiles or on automatic driving of automobiles has begun recently (Japanese Unexamined Patent Application Publication No. 2005-067483).

For instance, in research on automatic driving of automobiles, studies on automatic travel along scheduled routes or automatic travel control to avoid collision on the basis of collision risk prediction are currently underway.

However, even if such sophisticated automatic driving technology is realized, it is still difficult to avoid collision.

Accordingly, even if sophisticated automatic driving technology for vehicles such as automobiles is realized, not all collisions of automobiles can be avoided, and it is desirable to take further measures to mitigate collisions.

### SUMMARY OF THE INVENTION

An aspect of the present invention provides a collision-input reduction apparatus for a vehicle. The collision-input reduction apparatus includes a detector configured to detect an approaching object that approaches the vehicle, a controller configured to control behavior of the vehicle. In response to prediction, based on detection by the detector, of a collision of the approaching object with a side of the vehicle in a direction passing through a center of gravity of the vehicle while traveling, the controller changes the behavior of the vehicle before collision with the approaching object so as to move the center of gravity of the vehicle off an input direction of impact caused by the collision with the approaching object.

The controller may perform one or both of deceleration control of the vehicle and acceleration control of the vehicle to change the behavior of the vehicle.

The controller may reduce deceleration of the vehicle during deceleration control of the vehicle.

The controller may control the behavior of the vehicle only when at least deceleration control is being performed on the vehicle using automatic vehicle driving or using driving assistance control.

### BRIEF DESCRIPTION OF THE DRAWINGS

FIG. 1 is a diagram illustrating an automobile that may include an occupant protection device of a collision-input reduction apparatus for a vehicle according to an example of the present invention;

FIG. 2 is a diagram illustrating the collision-input reduction apparatus for a vehicle according to the example of the present invention;

FIGS. 3A to 3C are diagrams illustrating an example of a collision-input reduction process performed when the front of one side of a vehicle while traveling is impacted during a collision from the side; and

FIGS. 4A to 4C are diagrams illustrating another example of the collision-input reduction process performed when the front of one side of a vehicle while traveling is impacted during a collision from the side.

### DETAILED DESCRIPTION

Examples of the present invention will be described hereinafter with reference to the drawings.

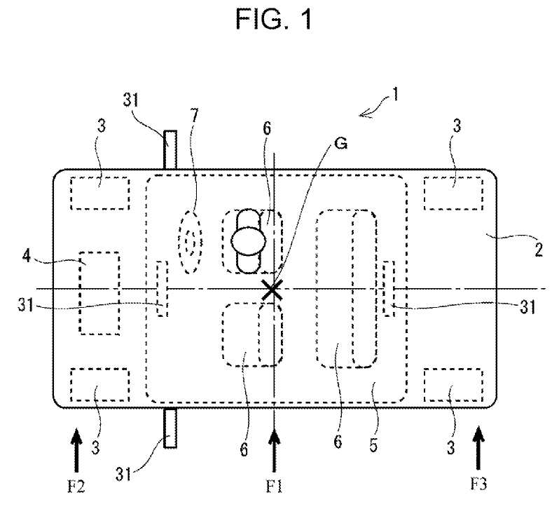

FIG. 1 is a diagram illustrating an automobile 1 that may include an occupant protection device 10 of a collision-input reduction apparatus 9 for the automobile 1 according to an example of the present invention.

FIG. 1 illustrates the automobile 1 as viewed from above. The automobile 1 is an example of a vehicle.

The automobile 1 illustrated in FIG. 1 has a body 2. Wheels 3 are disposed at the four corners of the body 2. An engine 4 or a motor serving as a power source 35 is disposed in a front portion of the body 2.

The body 2 has a passenger compartment 5 in which a plurality of seats 6 for occupants are disposed. A steering wheel 7, an accelerator pedal (not illustrated), and a brake pedal (not illustrated) are disposed in front of the right front seat 6. An occupant on the seat 6 operates the steering wheel 7 and so on to allow the automobile 1 to move forward, stop, move backward, turn to the right, or turn to the left.

For instance, in research on automatic driving of the automobile 1, studies on automatic travel control along a scheduled route or automatic travel control to avoid collision on the basis of collision risk prediction are currently underway.

However, even if such sophisticated automatic driving technology is realized, it is still difficult to completely avoid collision.

Accordingly, even if sophisticated automatic driving technology for a vehicle such as the automobile 1 is realized, not all collisions of the automobile 1 can be avoided, and it is desirable to take further measures to mitigate collisions.

When an approaching object collides with the side of the body 2, as illustrated in FIG. 1, the front of the side (F2), the side center (F1), or the rear of the side (F3) of the body 2 may be impacted.

When the side center of the body 2 is impacted during a collision from the side, the first force F1 passes through the center of gravity G of the body 2. Thus, most of the first force F1 moves the entire body 2 backward. As a result, the entire automobile 1 will probably be pushed in the input direction F1 and rolled over or may flip and land upside down.

In contrast, when the front of the side of the body 2 is impacted during a collision from the side, the second force F2 is exerted on the front end of the body 2. Thus, most of the second force F2 rotates the body 2.

In this way, the behavior of the automobile 1 after collision can largely differ depending on whether the center of gravity G of the body 2 resides in the collision input direction.

The input direction of the impact applied by an approaching object may be a direction in which the center of gravity G of the approaching object moves, for example.

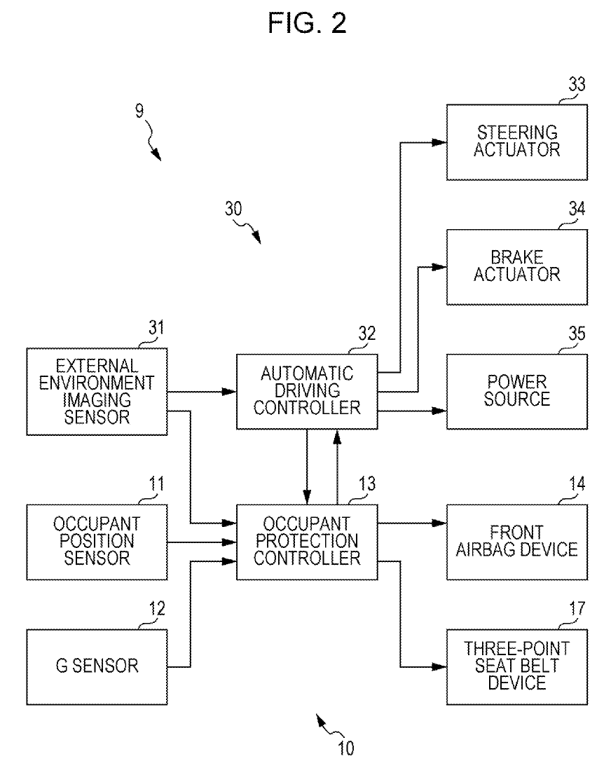

FIG. 2 is a diagram illustrating the collision-input reduction apparatus 9 for the automobile 1 according to the example of the present invention.

The collision-input reduction apparatus 9 illustrated in FIG. 2 is implemented as the occupant protection device 10 and an automatic driving control device 30.

The automatic driving control device 30 includes various external environment imaging sensors 31 illustrated in FIG. 1, an automatic driving controller 32, a steering actuator 33, a brake actuator 34, and the power source 35.

The steering actuator 33, instead of the steering wheel 7, steers the automobile 1.

The brake actuator 34, instead of the brake pedal, brakes the automobile 1.

The power source 35 is a gasoline engine or an electric motor, for example.

The automatic driving controller 32 controls the steering actuator 33, the brake actuator 34, and the power source 35 in accordance with, for example, the driving route to the destination.

The automatic driving controller 32 is coupled to the occupant protection device 10. The automatic driving controller 32 executes control to protect the occupants, such as collision avoidance control, in accordance with a signal from the occupant protection device 10.

Automatic driving control also includes control to assist the occupant in driving the automobile 1.

Through the control described above, the automatic driving controller 32 can control the behavior of the automobile 1.

The occupant protection device 10 illustrated in FIG. 2 includes an occupant position sensor 11, a G sensor 12, an occupant protection controller 13, a front airbag device 14, and a three-point seat belt device 17.

The occupant position sensor 11 detects the position of the head or the upper body of the occupant on the seat 6. The occupant position sensor 11 determines the amount of movement of the occupant on the seat 6 to the front or to either the right or left side in the vehicle width direction with respect to a seating position of the occupant who is seated with their back against the seat 6. The occupant position sensor 11 may be constituted by, for example, a plurality of proximity sensors arranged in the direction of detection.

The G sensor 12 detects the acceleration acting on the automobile 1. Examples of the direction of acceleration to be detected may include forward-backward, left-right, and up-down directions.

The front airbag device 14 includes a front airbag deployed in front of the upper body of the occupant on the seat 6, and an inflator for releasing gas into the front airbag.

The three-point seat belt device 17 includes a seat belt that is worn over the shoulder and across the waist of the occupant on the seat 6, and an actuator (not illustrated) that retracts the seat belt.

The occupant protection controller 13 is coupled to the external environment imaging sensor 31, the automatic driving controller 32, the G sensor 12, the occupant position sensor 11, the front airbag device 14, and the three-point seat belt device 17.

The occupant protection controller 13 identifies an approaching object that approaches the automobile 1 on the basis of the result obtained by the external environment imaging sensor 31, for example. Further, the occupant protection controller 13 predicts the risk of collision with the approaching object. When a collision occurs, the occupant protection controller 13 activates the front airbag device 14 and the three-point seat belt device 17 on the basis of the result obtained by the G sensor 12.

Further, the occupant protection controller 13 outputs a signal indicating the determination results obtained in the respective stages described above to the automatic driving controller 32.

In response to the input signal, the automatic driving controller 32 controls the steering actuator 33, the brake actuator 34, and the power source 35 to avoid a collision or reduce collision damage.

For instance, when the occupant protection controller 13 predicts a collision with an approaching object, the automatic driving controller 32 changes the behavior of the automobile 1 before collision with the approaching object so as to move the center of gravity G of the automobile 1 off the input direction of impact caused by the collision with the approaching object. In accordance with the approach to collision avoidance, the automatic driving controller 32 controls steering of the automobile 1 or individually controls braking of the wheels 3 of the automobile 1, for example. Additionally, the automatic driving controller 32 may individually control acceleration of the wheels 3 of the automobile 1 or perform acceleration control using the power source 35.

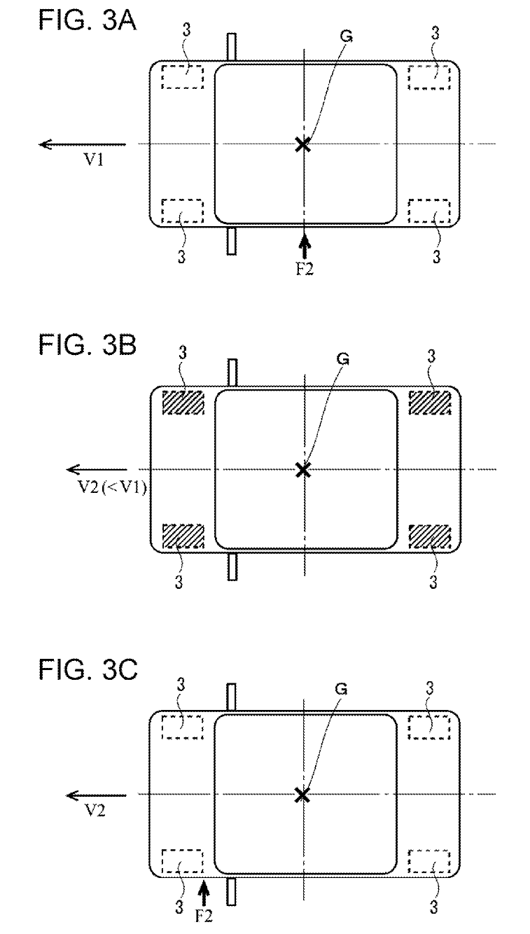

FIGS. 3A to 3C are diagrams illustrating an example of a collision-input reduction process performed when the front of one side of the automobile 1 while traveling is impacted during a collision from the side.

As illustrated in FIG. 3A, an approaching object collides broadside with the automobile 1 at the left side center. The center of gravity G of the automobile 1 resides in the input direction of the impact of the collision.

If this collision is predicted, the automatic driving controller 32 changes the behavior of the automobile 1 before collision so as to move the center of gravity G of the automobile 1 off the input direction of impact caused by the collision with the approaching object. In FIG. 3B, the four, front, rear, right and left wheels 3 are braked. Thus, the automobile 1 which is traveling is decelerated.

Thereafter, as illustrated in FIG. 3C, the automobile 1 actually collides with the approaching object at reduced speeds. As illustrated in FIG. 3C, the input direction of the actual collision is shifted forward from the center of gravity G of the automobile 1.

The automatic driving controller 32 may perform acceleration control of all of the four wheels 3 instead of braking all of the four wheels 3. Thus, the center of gravity G of the automobile 1 while traveling may be displaced from the input direction of impact caused by a collision with an approaching object. Therefore, an increase in the effect of shifting the center of gravity G of the automobile 1 from the input direction of collision is expected.

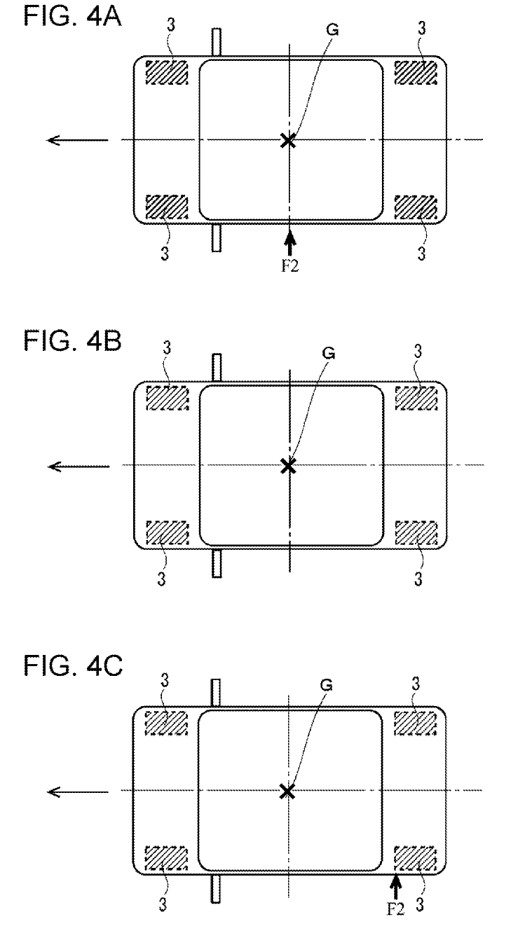

FIGS. 4A to 4C are diagrams illustrating another example of the collision-input reduction process performed when the front of one side of the automobile 1 while traveling is impacted during a collision from the side.

As illustrated in FIG. 4A, an approaching object collides broadside with the automobile 1 at the left side center while traveling at a reduced speed. The center of gravity G of the automobile 1 resides in the input direction of the impact of the collision. The automobile 1 while traveling at reduced speeds refers to the automobile 1 on which at least deceleration control is being performed using automatic vehicle driving or driving assistance control.

If this collision is predicted, the automatic driving controller 32 changes the behavior of the automobile 1 before collision so as to move the center of gravity G of the automobile 1 while traveling at reduced speeds off the input direction of impact caused by the collision with the approaching object. In FIG. 4B, the braking of the four, front, rear, right and left wheels 3 is relaxed. Thus, the deceleration of the automobile 1 which is traveling is reduced. This makes it difficult to decelerate the automobile 1.

Thereafter, as illustrated in FIG. 4C, the automobile 1 with relaxed braking actually collides with the approaching object while braking of the automobile 1 remains relaxed. Then, as illustrated in FIG. 4C, the input direction of the actual collision is shifted backward from the center of gravity G of the automobile 1.

Accordingly, as a result of reduced deceleration, the approaching object hits the automobile 1 at a portion posterior to the center of gravity G, which makes it easy for the automobile 1 to rotate after collision. In particular, as illustrated in FIG. 1, in the case where a heavy object such as the engine 4 is disposed in the front portion of the automobile 1, an approaching object hits the automobile 1 in the rear, which makes it easy for the automobile 1 to rotate after collision.

In particular, for instance, behavioral control is performed to shift the input direction of the actual collision forward or backward from the center of gravity G of the automobile 1 in the way described above only when at least deceleration control is being performed on the automobile 1 by using automatic vehicle driving or driving assistance control. This can increase the effect of mitigating collision impact during automatic driving without affecting the normal driving of the driver.

As described above, in the present example, the external environment imaging sensor 31 detects an approaching object that approaches the automobile 1 and the automatic driving controller 32 assists driving of the automobile 1 or performs automatic driving of the automobile 1. When it is predicted that an approaching object will collide broadside with the automobile 1 at the front of the side while traveling, the automatic driving controller 32 changes the behavior of the automobile 1 before collision with the approaching object so as to move the center of gravity of the automobile 1 off the input direction of impact caused by the collision with the approaching object. Thus, even if impact is input from an approaching object that has actually collided with the automobile 1, the energy of the impact causes the automobile 1 to rotate. Therefore, impact is less likely to be input to the center of gravity G of the automobile 1. The automobile 1 can convert input energy into rotational energy which can be utilized.

In an actual collision, an object collides with the automobile 1 at an area having a certain width. In this case, the control described above may be performed when, for example, the conditions described above for the input direction are satisfied at all positions over the width of the area to collide with.

In the present example, the automatic driving controller 32 performs deceleration control of the automobile 1 or acceleration control of the automobile 1 to change the behavior of the automobile 1. Accordingly, the behavior of the automobile 1 can be changed so that the center of gravity G of the automobile 1 is less likely to reside in the input direction of impact caused by a collision with an approaching object.

The example described above is an exemplary implementation of the present invention, and the present invention is not limited to this example. A variety of modifications or changes can be made without departing from the scope of the invention.

The automatic driving controller 32 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the automatic driving controller 32. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and an SRAM, and the non-volatile memory may include a ROM and an NVRAM. The ASIC is an integrated circuit (IC) customized to perform, and the FPGA is an integrated circuit designed to be configured after manufacturing in order to perform, all or a part of the functions of the automatic driving controller 32 illustrated in FIG. 2.

1. A collision-input reduction apparatus for a vehicle, the apparatus comprising:
a detector configured to detect an approaching object that approaches the vehicle; and
a controller configured to control behavior of the vehicle, wherein
in response to prediction, based on detection by the detector, of a collision of the approaching object with a side of the vehicle in a direction passing through a center of gravity of the vehicle while traveling, the controller changes the behavior of the vehicle before collision with the approaching object so as to move the center of gravity of the vehicle off an input direction of impact caused by the collision with the approaching object.

2. The collision-input reduction apparatus for a vehicle according to claim 1, wherein
the controller performs one or both of deceleration control of the vehicle and acceleration control of the vehicle to change the behavior of the vehicle.

3. The collision-input reduction apparatus for a vehicle according to claim 1, wherein
the controller reduces deceleration of the vehicle during deceleration control of the vehicle.

4. The collision-input reduction apparatus for a vehicle according to claim 2, wherein
the controller reduces deceleration of the vehicle during deceleration control of the vehicle.

5. The collision-input reduction apparatus for a vehicle according to claim 1, wherein
the controller controls the behavior of the vehicle only when deceleration control is being performed on the vehicle using at least automatic vehicle driving or driving assistance control.

6. The collision-input reduction apparatus for a vehicle according to claim 2, wherein
the controller controls the behavior of the vehicle only when deceleration control is being performed on the vehicle using at least automatic vehicle driving or driving assistance control.

7. The collision-input reduction apparatus for a vehicle according to claim 3, wherein
the controller controls the behavior of the vehicle only when deceleration control is being performed on the vehicle using at least automatic vehicle driving or driving assistance control.

8. The collision-input reduction apparatus for a vehicle according to claim 4, wherein
the controller controls the behavior of the vehicle only when deceleration control is being performed on the vehicle using at least automatic vehicle driving or driving assistance control.

9. A collision-input reduction apparatus for a vehicle, the collision-input reduction apparatus comprising:
a detector configured to detect an approaching object that approaches the vehicle; and
circuity configured to
control behavior of the vehicle, and
in response to prediction, based on detection by the detector, of a collision of the approaching object with a side of the vehicle in a direction passing through a center of gravity of the vehicle while traveling, change the behavior of the vehicle before collision with the approaching object so as to move the center of gravity of the vehicle off an input direction of impact caused by the collision with the approaching object.
